(19) United States
(12) Patent Application Publication
(10) Pub. No.: US 2024/0242004 A1
(43) Pub. Date: Jul. 18, 2024

(54) EFFICIENT STORAGE FOR ELECTRICAL GRID MODELS

(71) Applicant: X Development LLC, Mountain View, CA (US)

(72) Inventors: Raymond Daly, Palo Alto, CA (US); Sushant Kumar, San Jose, CA (US); Sergei Babinskii, Mountain Viw, CA (US); Amanda McNary, Redwood City, CA (US)

(21) Appl. No.: 18/155,475

(22) Filed: Jan. 17, 2023

(51) Int. Cl. G06F 30/18

(52) U.S. Cl. CPC G06F 30/18; G06F 2113/04

(57) ABSTRACT

Methods, systems, and apparatus, including medium-encoded computer program products, for efficient storage for electrical grid models, which can include the actions of obtaining a graph storage structure that can include component nodes, each component node representing a component of an electric grid within a computer simulatable model and which can include an identity of the component, wherein each component node is connected to one or more edges, and wherein each edge can include a version identifier, each edge connected to: (i) a second component node or (ii) a value node; obtaining graph update data that can include changes to at least one component; updating the graph storage structure according to the graph update data; and storing at least a subset of the graph update data in association with at least one new edge that includes information indicating the update data is relevant to a new version of the model.

### TECHNICAL FIELD

This specification relates to representing an electrical grid and its components as a graph storage structure that encodes multiple grid models and that enables resource-efficient versioning. The encoded models can be used to perform efficient grid simulations.

### BACKGROUND

Power grids contain thousands of miles of wires, millions of poles, and other expensive assets, e.g., transformers, capacitors, and switches. Electrical grids can include a broad range of interconnected components of various types such as inverters (Solar, Wind, HVDC, FACTS, etc.), relays, Power Plant Controllers (PPCs), Energy Management Systems, Remedial Action Systems (RAS), Automatic Generator Controls, alarm systems and so on. Computer simulatable models of electric grids include ever increasing amounts of data to accurately represent interconnections between the numerous components and maintain accurate models of each component. Technical improvements are needed to manage the size of electric grid models that allow for more efficient use of data storage resources and which reduce the time and computing resources required to load and update models.

### SUMMARY

This specification relates to representing an electrical grid and its components using a graph storage structure that enables resource-efficient versioning, and using the graph structure to perform efficient grid simulations. The graph storage structure is a storage schema for the highly interconnected electrical network supporting different types of traversals, versioning and change control. The storage schema can efficiently represent different temporal versions of electrical network interconnections between components, and can represent proposed changes to the grid, allowing such changes to be simulated before deployment. The storage schema can then be used to provide a simulatable model of the electric grid that can include historical changes and/or proposed changes made to the grid by changing the parameters and/or interconnection of the components as indicated by versioning data stored in the schema.

Particular embodiments of the subject matter described in this specification can be implemented so as to realize one or more of the following advantages. The techniques described below can be used to efficiently store multiple versions of electrical grid models. Since electrical grid models can include hundreds of thousands of nodes, and some models can include billions of nodes, the efficient storage techniques of this specification are essential for reducing the computing resources necessary to store model versions. In addition, the techniques of this specification can be used to efficiently generate particular versions of grid models, including versions based on proposed grid modifications, which can be used for electrical grid simulations, among other uses. As noted above, grid models can require substantial storage resources, so efficiently generating models can provide substantial technical benefits.

In general, innovative aspects of the subject matter described in this specification can be embodied in a non-transitory computer readable storage device storing multiple versions of an electric grid model in a graph storage structure that can include: a plurality of component nodes, each component node of the plurality of component nodes representing a component of an electric grid within a computer simulatable model of the electric grid and can include an identity of the component, wherein each component node is connected to one or more edges of a plurality of edges, and wherein each edge of the plurality of edges can include a property name for a property of the respective component and a version identifier, each edge connected to: (i) a second component node or (ii) a value node, wherein the value node can include a value for the property.

These and other implementations can each optionally include one or more of the following features.

In some implementations, at least one component node is connected to two or more edges both of which are also connected to a second component node, each of the two or more edges can include a different version identifier.

In some implementations at least one component node is connected to two or more edges both of which are also connected to a particular value node, each of the two or more edges can include a different version identifier.

In general, innovative aspects of the subject matter described in this specification can be embodied in methods that include the actions of obtaining a graph storage structure can include a plurality of component nodes, each component node of the plurality of component nodes representing a component of an electric grid within a computer simulatable model of the electric grid and can include an identity of the component, wherein each component node is connected to one or more edges of a plurality of edges, and wherein each edge of the plurality of edges can include a property name for a property of the respective component and a version identifier, each edge connected to: (i) a second component node or (ii) a value node, wherein the value node can include a value for the property; obtaining graph update data can include changes to at least one component of the graph storage structure; updating the graph storage structure according to the graph update data; and storing at least a subset of the graph update data in association with at least one new edge can include information indicating the update data is relevant to a new version of the computer simulateable model.

In some implementations, updating the graph storage structure according to the graph update data can include adding a new value node in association with at least one component node.

In some implementations, updating the graph storage structure according to the graph update data can include: creating at least one new edge that contains a new version identifier of the computer simulatable model and a property, wherein the at least one new edge includes references to two nodes, wherein the first node of the two nodes is a first component node, and the second node of the two nodes is either (i) a second component node or (ii) a value node.

In some implementations, in response to adding the new edge to the graph storage structure, a reference to the edge in a hash data structure can be included.

In some implementations, creating a new model version in the graph storage structure can include adding an edge that can include a version that is not included in any existing edge.

In some implementations, the graph update data can include an addition of a new electrical component to the electric grid model, and updating the graph storage structure can include: adding a new component node representing the new electrical component; adding at least one first edge connecting the new component node with at least one other component node, the at least one first edge indicating an electrical connection between the new electrical component and a respective electrical component associated with the at least one other component node; and adding at least one second edge and at least one new value node, wherein each of the at least one second edges can include a respective property name that identifies a respective property of the new electrical component and each of the at least one second edges connects the new component node to a respective one of the at least one new value nodes.

In some implementations, updating the graph storage structure can include assigning version identifiers to at least one first edge and to the at least one second edge indicating a new version of the computer simulateable model.

In some implementations, the graph update data can include a new electrical connection between a first existing electrical component and a second existing electrical component in the electric grid model, and updating the graph storage structure can include: identifying a first component ID associated with the first existing electrical component and a first existing component node that can include the first component ID, thereby indicating that the first existing component node represents the first existing electrical component; identifying a second component ID associated with the second existing electrical component and a second existing component node that can include the second component ID, thereby indicating that the second existing component node represents the second existing electrical component; adding a new edge connecting the first existing component node to the second existing component node.

In some implementations, updating the graph storage structure can include assigning a version identifier to the new edge indicating a new version of the computer simulateable model.

In some implementations, the graph update data can include a new value for an existing property of an existing electrical component in the electric grid model, and wherein updating the graph storage structure can include: identifying a component ID associated with the existing electrical component and a first existing component node that can include the first component ID, thereby indicating that the first existing component node represents the first existing electrical component; adding a new value node that can include the new value for the existing property; and adding a new edge connecting the existing component node to the new value node, the new edge that can include a same property name as another edge connected to the existing component node.

In some implementations, updating the graph storage structure can include assigning a version identifier to the new edge indicating a new version of the computer simulateable model.

In some implementations, the graph update data can include a new property for an existing electrical component in the electric grid model and a value for the new property, and wherein updating the graph storage structure can include: identifying a component ID associated with the existing electrical component and a first existing component node that can include the first component ID, thereby indicating that the first existing component node represents the first existing electrical component; adding a new value node that can include the value for the new property; and adding a new edge connecting the existing component node to the new value node, the new edge can include a name of the new property.

In some implementations, updating the graph storage structure can include assigning a version identifier to the new edge indicating a new version of the computer simulateable model.

In general, innovative aspects of the subject matter described in this specification can be embodied in methods that include the actions of obtaining a graph storage structure can include: a plurality of component nodes, each component node of the plurality of component nodes representing a component of an electric grid within a computer simulatable model of the electric grid and that can include an identity of the component, wherein each component node is connected to one or more edges of a plurality of edges, and wherein each edge of the plurality of edges can include a property name for a property of the respective component and a version identifier, each edge connected to: (i) a second component node or (ii) a value node, wherein the value node can include a value for the property; loading a particular version of the electric grid model, the loading can include: identifying a set of edges within the graph storage structure having a respective version identifier that correspond with the particular version; and generating the particular version of the electric grid model from component nodes and value nodes connected to the edges in the set of edges.

In some implementations, the method can include identifying a set of edges, wherein each respective edge in the set of edges include data indicating that the respective edge is associated with the particular version; identifying, for each particular edge of the set of edges, a component node and at least one of: (i) a component node associated with the particular edge, or (ii) a value node associated with the particular edge; and generating, using at least the identified component nodes and value nodes, and the subset of edges, a computer simulatable model corresponding to the particular version of the computer simulatable model.

In some implementations, the method can include identifying a set of edges within the graph storage structure having a respective version identifier which can include: identifying, for the edges within the graph storage structure, property names; and for each property name: determining an edge for which the version number is: (i) not lexicographically larger than the version identifier; and (ii) lexicographically closest to the version identifier; and including the edge in the graph structure for the particular version of the electric grid model.

In some implementations, at least one component node is connected to two or more edges both of which are also connected to a second component node, each of the two or more edges can include a different version identifier. The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A shows a graph storage structure for storing multiple versions of an electric grid model.

FIGS. 1B, 1C show examples of graph storage structures for storing multiple versions of an electric grid model.

FIG. 2 shows an example of an environment for determining electrical grid models.

FIG. 3 is a flow diagram of an example process for determining electrical grid models.

FIG. 4 is a block diagram of an example computer system.

Like reference numbers and designations in the various drawings indicate like elements.

### DETAILED DESCRIPTION

Electrical systems include a broad range of interconnected components of various types such as inverters (Solar, Wind, HVDC, FACTS, etc.), relays, Power Plant Controllers (PPCs), Energy Management Systems, Remedial Action Systems (RAS), Automatic Generator Controls, alarm systems and so on. The operation of one component can influence the operation of other components. For example, a PPC regulates and controls networked inverters within a power plant. Therefore, to avoid deleterious effects anywhere in the system, when any change is planned or proposed, it is important to understand the impact such change can have.

Electrical grid simulations (“grid simulation”) use a model of the components of the grid (e.g., inverters, relays, transformers, etc.) and an operational model to predict how a grid will operate under various conditions. Grid simulations can be used to test proposed changes to the components of a grid before such changes are deployed.

Both the grid model and the operational model are important to simulate behavior accurately. The model can include both the components of the grid and their interconnections. However, electrical grids are exceedingly complex, with hundreds of thousands of graph elements in a region, and at least billions of nodes worldwide. Simulating various changes in combination can rapidly exceed available computing resources. Therefore, efficient techniques are needed for storing the grid model, and for retrieving the elements of a grid model needed for an operational simulation.

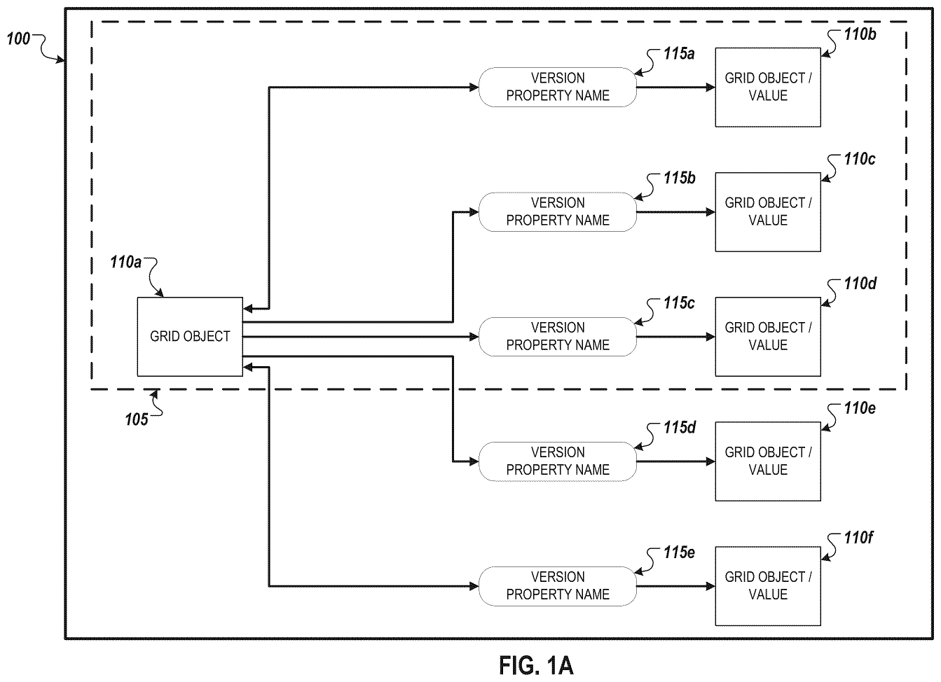

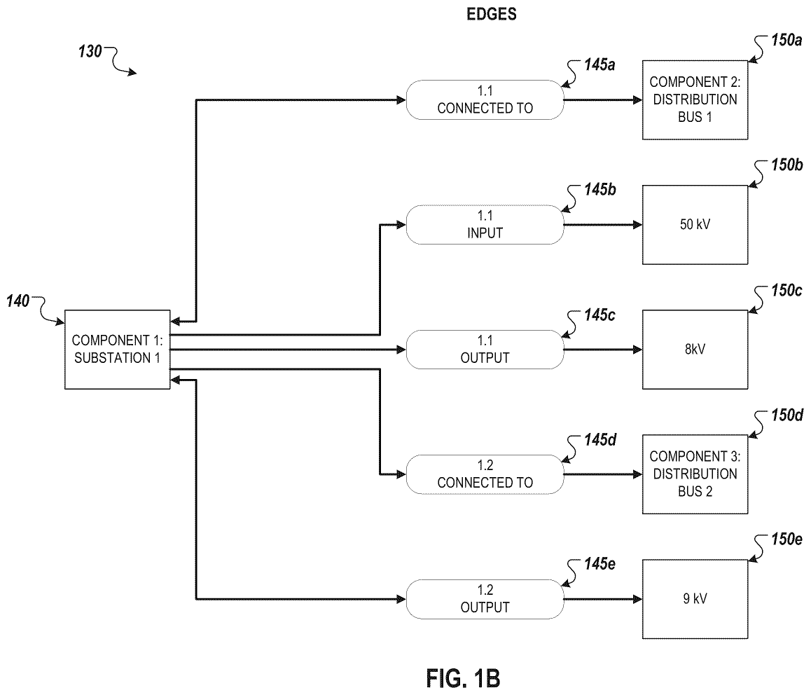

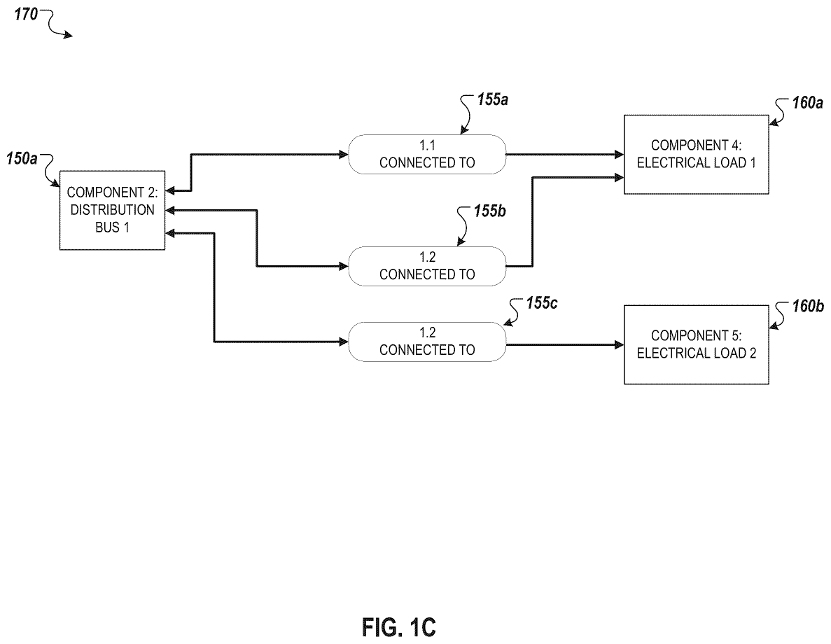

FIG. 1A shows a graph storage structure 100 (graph structure 100, for brevity) for storing multiple versions of electric grid models 105 (grid model 105, for brevity). The graph storage structure 100 can include component nodes 110a, 110b, 110c, 110d, 110e, 110f (collectively referred to as nodes 110) that can each represent a physical component of the electrical grid such as an inverter, relay, PPC, and power line, among many other examples. A node 110 can also contain an identifier and values, as described below, and references to edges 115a, 115b, 115c, 115d, 115e (collectively referred to as edges 115) that are connected to the node 110. Nodes that contain values can be called value nodes, and value nodes can represent that value of a property (as specified by an edge) of a component.

In some implementations, the identifier can be used as an index to obtain additional information about the grid object. For example, an identifier (e.g., “substation 1”) can be used to query a relational database using Structured Query Language (SQL) operations to retrieve properties such as the manufacturer, location, cost, maintenance manuals, and so on. In some implementations, the additional information can be stored in a graph database. In some implementations, the additional information can be stored in a node 110.

The graph storage structure 100 can also include edges 115 that can: (i) connect nodes 110; (ii) contain a property name; and (iii) contain grid model version numbers. The grid model version number enables the graph storage structure 100 to efficiently store multiple versions of a grid model 105, as described further below. The property name can indicate that, in the model version specified by the edge 115, a first node (e.g., node 110a) has a property as indicated by an edge (e.g., edge 115a) and the value of that property is included in the node connected by the edge (in this example, node 110b). The property names can be any appropriate naming system. For example, the property names can be defined by a Common Information Model (CIM), such as the CIM component of the International Electrotechnical Commission (IEC) 61970 standard. Edges 115 can also include references to nodes that connect into the edge. Such references can enable the system to determine, for an edge, nodes that connect to the edge and nodes that are connected from the edge.

The graph storage structure 100 can contain or encode electrical grid models 105 that include a subset of the nodes and edges included in the graph storage structure. In this example, grid model 105 contains nodes 110a, 110b, 110c and 110d, and edges 115a, 115b and 115c. The grid model 105 does not contain nodes 110e and 110f or edged 115c and 115d, which might be contained in other grid models that are generated from the graph storage structure 100.

FIG. 1B shows an example 130 of a graph structure for storing multiple versions of an electric grid model. In this example, a first node 140 has an identifier (ID) “component 1” and describes a particular substation, substation 1. The first node 140 is connected to five edges 145a, 145b, 145c, 145d, 145e. Edges 145a, 145b, 145c are associated with a first model version, called 1.1. Edge 145a indicates a property “connected to” and references node 150a. Node 150a describes distribution bus 1 and has ID “component 2.” Thus, in version 1.1 of the model, substation 1 is connected to distribution bus 1. Note that, in some implementations, the description (in this example “substation 1”) can be omitted and/or can be contained in a storage system (e.g., relational database) indexed by the component ID.

Continuing the example 130, node 150a is also connected to edges 145b and 145c, both associated with model version 1.1. Edge 145b connects to value node 150b, which indicates that the input to substation 1 is 50 kV. Edge 145c connects to value node 150c, which indicates that the output of substation 1 is 8 kV.

In the example 130, node 150a is also connected to two edges 145d and 145e that are associated with a second model version, called 1.2. Edge 145d indicates that, in model version 1.2, substation 1 is connected to node 150d, which represents distribution bus 2. Thus, in model version 1.2, substation 1 has changed to using distribution bus 2, instead of distribution bus 1 in version 1.1 as indicated by edge 145a and node 150a. In addition, edge 145e is connected to node 150e, indicating that the output in model version 1.2 increased to 9 kV from 8 kV in model version 1.1 (as indicated by node 150c). Since there is no edge indicating a change in the input value for model version 1.2, the input value remains the same, as indicated by edge 145b and node 150b.

FIG. 1C shows an example 170 of a graph structure for storing multiple versions of an electric grid model. In this example 170, component 2 150a is further connected to three edges 155a, 155b and 155c. Edge 155a indicates that in model version 1.1, node 150a (representing component 2) is connected to node 160a, which represents electrical load 1 (component 4). Edge 155b indicates that, in model version 1.2, node 150a (still representing component 2) remains connected to electrical load 1 (component 4), and is further connected to node 160c, which represents another electrical load, electrical load 2 (component 5). This example can arise, for example, when a distributed energy resource (e.g., solar power) is added to the grid. Therefore, model versions 1.1 and 1.2 differ in that distribution bus 1 (node 150a) is connected to electrical load 1 (node 160a) in version 1.1, and is connected to two electrical loads, electrical load 1 (node 160a) and electrical load 2 (node 160b) in version 1.2. Note that the examples 130, 170 are greatly simplified for clarity, and the graph structure can be arbitrarily large. As noted above, electrical grids commonly have hundreds of thousands of elements, and can have billions of elements.

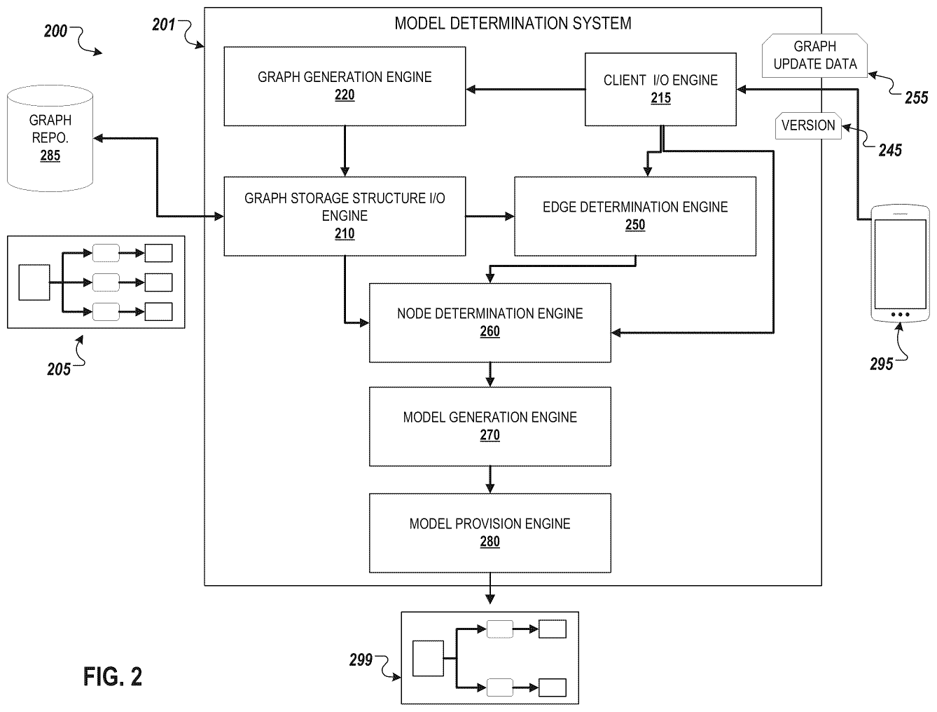

FIG. 2 shows an example of an environment 200 for determining electrical grid models. The environment can include a model determination system 201, a graph structure repository 285 and client devices 295.

The client devices 295 are electronic devices that are capable of communicating over a network, which can include wired networks and wireless networks. Example client devices 295 include personal computers, server computers, mobile communication devices, e.g., smart phones and/or tablet computers, and other devices that can send and receive data over the network. A client device 295 can include applications, such as web browsers and/or native applications, to facilitate the sending and receiving of data over the network. A native application is an application developed for a particular platform or a particular device (e.g., mobile devices having a particular operating system). Although operations may be described as being performed by the client device 295, such operations may be performed by an application running on the client device 295. A client device 295 can use a web browser, native application and/or other software running on the client device 295 to provide information to the model determination system 201, including model version specifications 245 and graph update data 255.

A model version specification 245 can be any appropriate indicator for a model version. For example, a model version specification 245 can be a character string such as “1a”, “1b”, “2a”, etc. or a number such as 1.1, 1.2, 2.1, and so on. Model version specifications 245 can also be encoded as structured text such as Extensible Markup Language (XML). For example, a model version specification for 2.3 can be encoded as: <MODEL_VERSION><MAJOR_VERSION>2</MAJOR_VERSION><MINOR_VERSION>3</MINOR_VERSION></MODEL_VERSION>. A model version specification 245 can also be arbitrarily complex. For example, a character string indicating a version can be “1.2.3.4.5.6”.

A model version specification 245 can have an inherent structure. For example, a model version specification 245 can have a structure “a.b.c. . . . ”, where “a”, “b”, “c”, and so on are integers. For example, model version specifications 245 can be “1.1.1”, “1.1.2”, “2.1.1”, and so on. In such cases, model version 1.1.1 is an earlier version than 1.1.2, and 1.1.2 is an earlier version than 2.1.1. In some implementations, the order of model version specifications 245 is lexicographic.

In some implementations, the model version specification 245 can include or refer to a timestamp for the version. In various examples, the model version specification 245 can be a timestamp of a format such as “year-month-day-hour: minute: second” (e.g., 2022-06-12-11:20:30); the model version specification 245 can include a timestamp (e.g., 25.5.2-2022-06-12-11:20:30); refer to a timestamp (e.g., model version specification 245 “25.5.2” can be used as an index into a relational database that contains the timestamp of version 25.5.2); and so on.

Graph update data 255 can express one or more updates to a graph structure 205, which can include the adding, modification or deletion of any node or edge of a graph structure 205. Graph update data 255 can use any appropriate encoding of the update. For example, graph update data 255 can be expressed in XML or JavaScript Object Notation (JSON). Each update included in graph update data 255, can indicate the type of update (e.g., add, modify, delete), the element type (e.g., node or edge), and component of the element being updated (e.g., identifier or value of a node), and the value(s), or a subset of these fields. For example, a graph update in graph update data 255 can indicate that it is an addition of a node, and the new node has the identifier “Component 123” and represents Substation 7.

The graph structure repository 285 can be any storage system appropriate for storing graph storage structures 205 (graph structure 205, for brevity), which can be the graph storage structure 100 of FIG. 1A. For example, the graph structure repository 285 can include one or more relational databases, object databases, file systems, block storage devices, and other suitable storage systems in any combination. The graph structure repository 285 can include an Application Programming Interface (API) that is configured to accept requests from components in the environment (e.g., the model determination system 201) and to provide the requested graph structures 205. The graph structure repository 285 can accept graph structures 205 from the model determination system 201, and can provide graph structures 205 to the model determination system 201.

The model determination system 201 can obtain graph structures 205, model version specifications 245 from client devices 295, and can determine a graph model 299 using the graph structures 205 and the model version specifications 245. The model determination system 201 can include a graph storage structure input/output (I/O) engine 210, a client I/O engine 215, a graph generation engine 220, an edge determination engine 250, a node determination engine 260, a model generation engine 270, and a model provision engine 280.

The graph storage structure I/O engine 210 can obtain graph structures 205 from the graph structure repository 285 and provide the graph structures 205 to the graph structure repository. The graph storage structure I/O engine 210 can further provide graph structures 205 to the edge determination engine 250 for use in graph model 299 generation. The graph storage structure I/O engine 210 can call an API provided by the graph structure repository 285 to obtain and provide the graph structure 205. The API can be any appropriate API such as a WebServices API, a local procedure or method call, a remote procedure call (RPC), and so on.

The client I/O engine 215 can accept data from client devices 295. Data can include a model version specification 245 and graph update data 255. The client I/O engine can provide the model version specification 245 to the edge determination engine 250 and can provide graph update data 255 to the graph generation engine 220. The client I/O engine 215 can include an API that is configured to accept data from a client device 295. The API can be of any appropriate type such as a WebServices API, a local procedure or method call, and RPC, and so on.

The graph generation engine 220 can obtain graph update data 255 from the client I/O engine 215, and use the graph update data 255 to modify a graph structure 205. The graph generation engine 220 can provide the modified graph structure 205 to the graph storage structure I/O engine 210 for storage in the graph structure repository 285.

The edge determination engine 250 can work in conjunction with the node determination engine 260 to determine the nodes and edges of a graph structure 205 to be included in a particular graph model 299 version. Both the edge determination engine 250 and the node determination engine 260 can accept a model version specification 245 from the client I/O engine 215 and graph structures 205 from the graph storage structure I/O engine 210. The node determination engine 260 can also accept edges identified as part of a particular version of a graph model 299 from the edge determination engine 250, and use the version numbers in those edges to determine the nodes to be included in a particular graph model version 299.

The model generation engine 270 can accept a list of edges from the edge determination engine 250 and a list of nodes from the node determination engine 260, and use the edges and nodes to generate a graph model version 299 that includes the nodes and edges appropriate for the model version specification 245. The model generation engine 270 can provide the model version 299 to the model provision engine 280.

The model provision engine 280 can make the graph model 299 available for use by components such as electrical grid simulators, graph visualization engines and client devices 295. The model provision engine 280 can use any appropriate technique for providing the graph model 299. For example, the model provision engine 280 can provide the model 299 to a web server and/or the model provision engine 280 can include a web server. Other components can obtain the graph model 299 using Hypertext Transfer Protocol (HTTP) or HTTP-Secure (HTTP-S). In another example, the model provision engine 280 can store the graph model 299 on a file system, and other components can obtain the graph model 299 using appropriate file system operations.

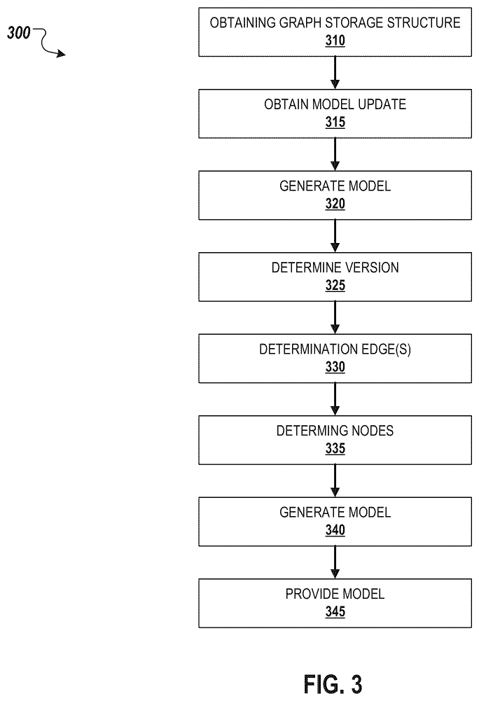

FIG. 3 is a flow diagram of an example process for determining electrical models. For convenience, the process 300 will be described as being performed by a system for model determination, e.g., the model determination system 201 of FIG. 1, appropriately programmed to perform the process. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

The system can obtain (310) a graph structure for a computer simulatable model of the electric grid. The system can obtain the graph structure from a graph structure repository using any appropriate technique. For example, if the repository is a relational database, the system can retrieve the graph structure using SQL operations. In another example, if the repository is a file system, the system can retrieve the graph structure using file system operations.

The system can obtain (315) one or more graph structure updates that include graph update data. In some implementations, the system can include an API which, when called by a client device, enables a client device to provide graph update data that specifies an update for a graph structure. In some implementations, the system can retrieve graph update data from a data repository, e.g., a file system, using techniques appropriate for the data repository.

The system can generate (320) a new version of the graph storage structure that incorporates the graph update data by updating the graph structure. As noted above, the types of updates in the graph update data can include additions, changes and deletions, and each update specifies the component ID.

When the update is an addition of a node, the graph update data can specify a new component node, a new value node, or both. If the addition is a component node, the system can create a new component node that contains the component ID and can contain a component descriptor. If the graph update data further includes a descriptor of the edge(s) to which the component is to be connected, the system can add references in the new component node to the edge(s).

When the new node is a value node, the system can create the value node that contains the value data as specified by the graph update data. In addition, the graph update data can include the edge(s) that connect to the new value node. Such edges create an association between a component node representing a component and the newly created value node. The edges further indicate that the update is relevant to a version of the computer simulateable model, which can be a new version of the computer simulateable model, as described further below.

When the update is an addition of an edge, the graph update data can specify the model version, the property, connections to the edge and connection(s) from the edge. The system can create a new edge that contains the model version and property. The system can include in the edge note a reference to the connections from the edge node and the connections to the edge node. The system can also update nodes that are connected to the new edge by adding a reference in those nodes to the edge. If the version in an added edge has not previously been used, that version creates a new model version. For example, if the version in an edge is 1.2, and 1.2 has not previously been included in an edge, then 1.2 is a new model version.

In some implementations, the system can include one or more data structures that contain references to edges. The data structure(s) can enable the system to determine edges by a property, by a version, and/or by a combination of the property and version. For example, a first hash table can include a key that is a property name, a second hash table can include a key that is a version, and/or a third hash table can include a key that is a combination of property name and version, e.g., by concatenating the property name and version. The hash table buckets can include the edges associated with the property name, version and/or property name and version. When a new edge is created, the edge can be inserted into the hash table according to its property name and version.

When the update is a node modification, the graph update data can contain a component ID. The system can use the component ID to determine a node with the component ID, and adjust the information in the node according to the information in the graph update data.

When the update is a node deletion, the graph update data can contain a component ID. The system can use the component ID to determine a node with the component ID, and delete the node from the graph structure. Note that some implementations can support only additions to the graph structure, support only additions and modifications or support only additions and deletions.

The system can determine (325) a version of the computer simulatable model using any appropriate techniques. For example, the system can include an API, which when called by a client device, enables the client device to provide a version of the computer simulatable model. In another example, the system can obtain the version from a storage system using a technique appropriate for the storage system.

The system can determine (330) the edges in the graph structure for the version of the computer simulatable model. As described above each edge has a version, and versions can be ordered lexicographically. To determine the edges in a graph structure, the system finds, for each property, the edge whose version number is closest to the version without going over. In some implementations, the system can determine, for each property, the edge that (i) is not lexicographically larger than the model version number; and (ii) is lexicographically closest to the version. For example, if the determined version (per operation 325) is 2.1.1 and for some property P, an edge has version 2.1.1, then that edge will be selected since the versions match exactly. However, if no edge has version 2.1.1, the system determines the edge for property P with a version lexicographically below 2.1.1 that is lexicographically closest to 2.1.1. For example, if the graph structure includes edges for property P with versions 1.1.1, 1.1.2 and 2.2.1, the system will select 1.1.2 since, using lexicographic order, 2.2.1 is larger than 2.1.1 and 1.1.2 is closer to 2.1.1 than is 1.1.1. If no such edge exists, then no edge with that property is included in that model version.

The system can determine (335) the nodes associated with the edges in the graph structure for the version of the computer simulatable model. As described above, an edge can include references to and from the edge. The system can use those references to determine, for each edge, the nodes that connect to the edge, and the nodes that connect from the edge.

The system can generate (340) a model that includes the nodes and edges. Since the system has determined the edges (operation 330) and the nodes (operation 335), and the nodes contain references to edges and the edges contain references for nodes, the system can create a model that contains the determined edges and nodes using the references in the nodes and edges.

The system can provide (345) the model using any appropriate technique. For example, the system can include an API that is configured to provide models. In another example, the system can store the model (e.g., the graph data structure generated in operation 350) on an appropriate storage system such as a file system or a relational database. In still another example, the system can provide the model to a web server where it can be accessed using HTTP or HTTP-S.

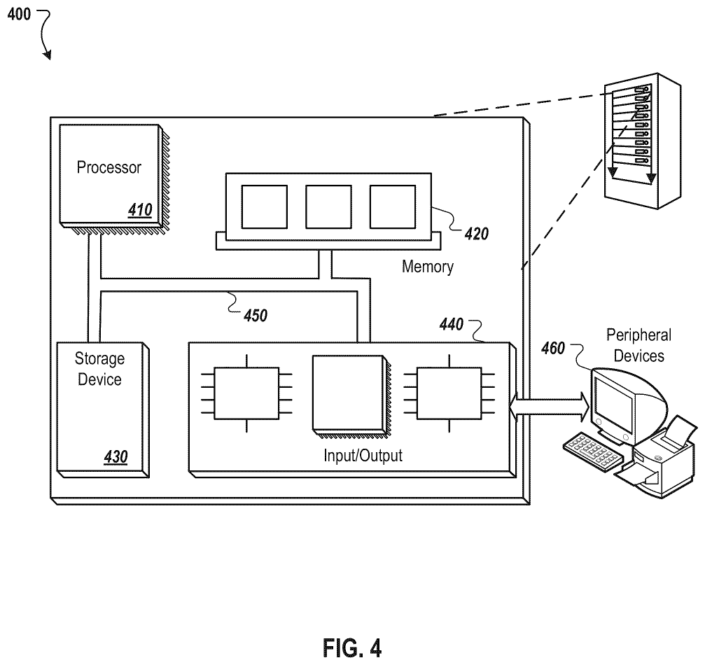

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A non-transitory computer readable storage device storing multiple versions of an electric grid model in a graph storage structure comprising:
a plurality of component nodes, each component node of the plurality of component nodes representing a component of an electric grid within a computer simulatable model of the electric grid and comprising an identity of the component, wherein each component node is connected to one or more edges of a plurality of edges, and wherein each edge of the plurality of edges comprises a property name for a property of the respective component and a version identifier, each edge connected to: (i) a second component node or (ii) a value node, wherein the value node comprises a value for the property.

2. The storage device of claim 1, wherein at least one component node is connected to two or more edges both of which are also connected to a second component node, each of the two or more edges comprising a different version identifier.

3. The storage device of claim 1, wherein at least one component node is connected to two or more edges both of which are also connected to a particular value node, each of the two or more edges comprising a different version identifier.

4. An electric grid model version control method comprising:
obtaining a graph storage structure comprising a plurality of component nodes, each component node of the plurality of component nodes representing a component of an electric grid within a computer simulatable model of the electric grid and comprising an identity of the component, wherein each component node is connected to one or more edges of a plurality of edges, and wherein each edge of the plurality of edges comprises a property name for a property of the respective component and a version identifier, each edge connected to: (i) a second component node or (ii) a value node, wherein the value node comprises a value for the property;
obtaining graph update data comprising changes to at least one component of the graph storage structure;
updating the graph storage structure according to the graph update data; and
storing at least a subset of the graph update data in association with at least one new edge comprising information indicating the update data is relevant to a new version of the computer simulateable model.

5. The method of claim 4, wherein updating the graph storage structure according to the graph update data comprises adding a new value node in association with at least one component node.

6. The method of claim 4, wherein updating the graph storage structure according to the graph update data comprises:
creating at least one new edge that contains a new version identifier of the computer simulatable model and a property, wherein the at least one new edge includes references to two nodes, wherein a first node of the two nodes is a first component node, and the second node of the two nodes is either (i) a second component node or (ii) a value node.

7. The method of claim 6, wherein, in response to adding the new edge to the graph storage structure, including a reference to the edge in a hash data structure.

8. The method of claim 4, wherein creating a new model version in the graph storage structure comprises adding an edge that comprises a version that is not included in any existing edge.

9. The method of claim 4, wherein the graph update data comprises an addition of a new electrical component to the electric grid model, and
wherein updating the graph storage structure comprises:
adding a new component node representing the new electrical component;
adding at least one first edge connecting the new component node with at least one other component node, the at least one first edge indicating an electrical connection between the new electrical component and a respective electrical component associated with the at least one other component node; and
adding at least one second edge and at least one new value node, wherein each of the at least one second edges comprise a respective property name that identifies a respective property of the new electrical component and each of the at least one second edges connects the new component node to a respective one of the at least one new value nodes.

10. The method of claim 9, wherein updating the graph storage structure comprises assigning version identifiers to at least one first edge and to the at least one second edge indicating a new version of the computer simulateable model.

11. The method of claim 4, wherein the graph update data comprises a new electrical connection between a first existing electrical component and a second existing electrical component in the electric grid model, and
wherein updating the graph storage structure comprises:
identifying a first component ID associated with the first existing electrical component and a first existing component node comprising the first component ID, thereby indicating that the first existing component node represents the first existing electrical component;
identifying a second component ID associated with the second existing electrical component and a second existing component node comprising the second component ID, thereby indicating that the second existing component node represents the second existing electrical component; and
adding a new edge connecting the first existing component node to the second existing component node.

12. The method of claim 11, wherein updating the graph storage structure comprises assigning a version identifier to the new edge indicating a new version of the computer simulateable model.

13. The method of claim 4, wherein the graph update data comprises a new value for an existing property of an existing electrical component in the electric grid model, and
wherein updating the graph storage structure comprises:
identifying a component ID associated with the existing electrical component and a first existing electrical component node comprising a first component ID, thereby indicating that the first existing electrical component node represents the first existing electrical component;
adding a new value node comprising the new value for the existing property; and
adding a new edge connecting the existing component node to the new value node, the new edge comprising a same property name as another edge connected to the existing component node.

14. The method of claim 13, wherein updating the graph storage structure comprises assigning a version identifier to the new edge indicating a new version of the computer simulateable model.

15. The method of claim 4, wherein the graph update data comprises a new property for an existing electrical component in the electric grid model and a value for the new property, and
wherein updating the graph storage structure comprises:
identifying a component ID associated with the existing electrical component and a first existing component node comprising a first component ID, thereby indicating that the first existing component node represents a first existing electrical component;
adding a new value node comprising the value for the new property; and
adding a new edge connecting the existing component node to the new value node, the new edge comprising a name of the new property.

16. The electric grid model version control method of claim 15, wherein updating the graph storage structure comprises assigning a version identifier to the new edge indicating a new version of the computer simulateable model.

17. An electric grid model loading method comprising:
obtaining a graph storage structure comprising:
a plurality of component nodes, each component node of the plurality of component nodes representing a component of an electric grid within a computer simulatable model of the electric grid and comprising an identity of the component, wherein each component node is connected to one or more edges of a plurality of edges, and wherein each edge of the plurality of edges comprises a property name for a property of the respective component and a version identifier, each edge connected to: (i) a second component node or (ii) a value node, wherein the value node comprises a value for the property;
loading a particular version of the electric grid model, the loading comprising:
identifying a set of edges within the graph storage structure having a respective version identifier that correspond with the particular version; and
generating the particular version of the electric grid model from component nodes and value nodes connected to the edges in the set of edges.

18. The method of claim 17, further comprising:
identifying a subset of edges, wherein each respective edge in the subset of edges include data indicating that the respective edge is associated with the particular version;
identifying, for each particular edge of the subset of edges, a component node and at least one of: (i) a component node associated with the particular edge, or (ii) a value node associated with the particular edge; and
generating, using at least the identified component nodes and value nodes, and the subset of edges, a computer simulatable model corresponding to the particular version of the computer simulatable model.

19. The method of claim 17 wherein identifying a set of edges within the graph storage structure having a respective version identifier comprises:
identifying, for the edges within the graph storage structure, property names; and
for each property name:
determining an edge for which a version number is: (i) not lexicographically larger than the version identifier; and (ii) lexicographically closest to the version identifier; and
including the edge in the graph structure for the particular version of the electric grid model.

20. The method of claim 17, wherein at least one component node is connected to two or more edges both of which are also connected to a second component node, each of the two or more edges comprising a different version identifier.
